(19) United States
(12) Patent Application Publication
(10) Pub. No.: US 2026/0148062 A1
(43) Pub. Date: May 28, 2026

(54) METHOD FOR PARALLEL EXECUTION OF MULTIPLE DEEP-LEARNING MODELS AND APPARATUS THEREFOR

(71) Applicant: Electronics and Telecommunications Research Institute, Daejeon (KR)

(72) Inventors: Mi-Sun YU, Daejeon (KR); Yong-In KWON, Daejeon (KR)

(73) Assignee: Electronics and Telecommunications Research Institute, Daejeon (KR)

(21) Appl. No.: 19/290,469

(22) Filed: Aug. 5, 2025

(30) Foreign Application Priority Data
Nov. 25, 2024 (KR) 10-2024-0169953

(51) Int. Cl. G06N 3/08; G06N 5/04

(52) U.S. Cl. CPC G06N 3/08; G06N 5/04

(57) ABSTRACT

Disclosed herein are a method for parallel inference for multiple deep-learning models and an apparatus for the same. The method performed by the apparatus includes transforming each of multiple deep-learning models into partitions executable on accelerators by partitioning the deep-learning model, deploying the partitions to per-accelerator partition managers based on a partition execution order determined in consideration of inter-partition dependencies, extracting target partitions associated with input data for each target model from the per-accelerator partition managers and inputting the target partitions into accelerators matched with the target partitions when the input data for each target model is provided according to an inference execution request, and outputting an inference result for each target model by running the accelerators, into which the target partitions are input, in parallel.

### CROSS REFERENCE TO RELATED APPLICATION

This application claims the benefit of Korean Patent Application No. 10-2024-0169953, filed Nov. 25, 2024, which is hereby incorporated by reference in its entirety into this application.

### BACKGROUND OF THE INVENTION

### 1. Technical Field

The present disclosure relates to inference scheduling and compilation technology for minimizing model response latency and optimizing system resources by executing multiple deep-learning models in parallel on different heterogeneous hardware accelerators.

### 2. Description of the Related Art

Recent deep-learning compilers, i.e., TVM, Glow, XLA, TensorRT, etc., provide functionality to transform deep-learning models written in PyTorch or TensorFlow into code executable on various types of hardware, such as CPUs, GPUs, NPUs, and the like. These compilers enable efficient inference even on resource-constrained edge devices through static optimization, operator fusion, quantization, and the like.

Some compilers are designed to enable execution in a multi-device environment, but most compilers transform an entire model to suit a single hardware accelerator, and parallel partitioning or scheduling functions required for distributed execution across multiple devices are not sufficiently generalized. For example, in an environment where heterogeneous accelerators such as NVIDIA Jetson Nano, Google Coral Edge TPU, and Intel Movidius Myriad X coexist, the functions to automatically partition a model and perform parallel execution by reflecting the computational performance or characteristics of each accelerator are still limited.

Also, applications that process different types of input data, such as voice, images, video, etc., in a single system often require concurrent execution of multiple deep-learning models. Here, because each model has a different inference cycle and accelerator utilization, some accelerators remain idle while specific accelerators experience concentrated load, which may result in the problem of decreasing the responsiveness of the overall system. In order to solve this problem, technology capable of efficiently distributing multiple models across various heterogeneous accelerators and executing the models in parallel is required.

### Documents of Related Art

(Patent Document 1) Korean Patent Application Publication No. 10-2023-0043565, published on Mar. 31, 2023 and titled “Electronic device for co-locating models and operating method thereof”.

### SUMMARY OF THE INVENTION

An object of the present disclosure is to provide technology for maximizing overall system throughput and reducing response time by appropriately partitioning each model and performing scheduling for parallel execution in consideration of computational characteristics of each model and processing performance of heterogeneous accelerators mounted on a target device in a complex application environment in which multiple deep-learning inference models should be concurrently executed.

Another object of the present disclosure is to provide execution management technology that is capable of automatically transforming a single deep-learning model into partitions, which are execution units for each accelerator, through hardware-independent graph optimization and subgraph partitioning and appropriately mapping the partitions to various accelerator resources, thereby controlling the execution order.

A further object of the present disclosure is to reduce the development time of an artificial intelligence (AI) application that requires various deep-learning models and to improve the execution performance.

Yet another object of the present disclosure is to enable multiple deep-learning models to operate concurrently even on a device that includes heterogeneous accelerators supporting only a specific operation, without high-performance GPUs.

In order to accomplish the above objects, a method for parallel inference for multiple deep-learning models, which is performed by a parallel inference apparatus, according to the present disclosure includes transforming each of multiple deep-learning models into partitions executable on accelerators by partitioning the deep-learning model, deploying the partitions to per-accelerator partition managers based on a partition execution order determined in consideration of inter-partition dependencies, extracting target partitions associated with input data for each target model from the per-accelerator partition managers and inputting the extracted target partitions into accelerators matched with the target partitions when the input data for each target model is provided according to an inference execution request, and outputting an inference result for each target model by running the accelerators, into which the target partitions are input, in parallel.

Here, the partition may include partition code and a partition ID, and the partition code may be generated to correspond to code in a format executable on accelerators by optimizing subgraphs to be executed on the accelerators.

Here, transforming each of the multiple deep-learning models may comprise matching operators of a graph, acquired by performing hardware-independent graph optimization on the multiple deep-learning models, with accelerators and generating a single independent subgraph for consecutive operations executed on the same accelerator.

Here, matching the operators with the accelerators may be performed based on a partition performance model and an execution wait time of each accelerator such that the execution time of the entire subgraph is minimized.

Here, the partition performance model may include a partition execution time, including a time taken by an accelerator to execute a partition, a time required to transmit input data for executing the partition, and a time required to retrieve output data.

Here, the partition performance model may be generated by monitoring performance of the accelerators over a preset period.

Here, the execution time of the entire subgraph may include a partition execution time, a time required to transmit/receive input/output data, and an execution wait time.

Here, the accelerators into which the target partitions are input may concurrently operate.

Here, the inference result may be generated upon completion of execution of the last target partition that constitutes the target model.

Also, an apparatus for parallel inference according to an embodiment of the present disclosure includes a deep-learning compiler for transforming each of multiple deep-learning models into partitions executable on accelerators by partitioning the deep-learning model, a partition deployment module for deploying the partitions to per-accelerator partition managers based on a partition execution order determined in consideration of inter-partition dependencies, and a multi-model execution module for extracting target partitions associated with input data for each target model from the per-accelerator partition managers and inputting the target partitions into accelerators matched with the target partitions when the input data for each target model is provided according to an inference execution request and for outputting an inference result for each target model by running the accelerators, into which the target partitions are input, in parallel.

Here, the partition may include partition code and a partition ID, and the partition code may be generated to correspond to code in a format executable on accelerators by optimizing subgraphs to be executed on the accelerators.

Here, the deep-learning compiler may match operators of a graph, acquired by performing hardware-independent graph optimization on the multiple deep-learning models, with accelerators and generate a single independent subgraph for consecutive operations executed on the same accelerator.

Here, matching the operators with the accelerators may be performed based on a partition performance model and an execution wait time of each accelerator such that the execution time of the entire subgraph is minimized.

Here, the partition performance model may include a partition execution time, including a time taken by an accelerator to execute a partition, a time required to transmit input data for executing the partition, and a time required to retrieve output data.

Here, the apparatus may further include a runtime partition performance monitor for generating the partition performance model by monitoring performance of the accelerators over a preset period.

Here, the execution time of the entire subgraph may include a partition execution time, a time required to transmit/receive input/output data, and an execution wait time.

Here, the accelerators into which the target partitions are input may concurrently operate.

Here, the inference result may be generated upon completion of execution of the last target partition that constitutes the target model.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for parallel inference for multiple deep-learning models according to an embodiment of the present disclosure;

FIG. 2 is a view illustrating a system for parallel inference for multiple deep-learning models according to an embodiment of the present disclosure;

FIG. 3 is a view illustrating in detail the structure of the deep-learning compiler illustrated in FIG. 2;

FIG. 4 is a view illustrating in detail the structure of the target device illustrated in FIG. 2;

FIG. 5 is a flowchart illustrating in detail a model deployment procedure in a parallel inference method according to an embodiment of the present disclosure;

FIG. 6 is a flowchart illustrating in detail a model execution procedure in a parallel inference method according to an embodiment of the present disclosure; and

FIG. 7 is a view illustrating an example of a process of executing two deep-learning models in parallel across three accelerators according to the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, a preferred embodiment of the present disclosure will be described in detail with reference to the accompanying drawings.

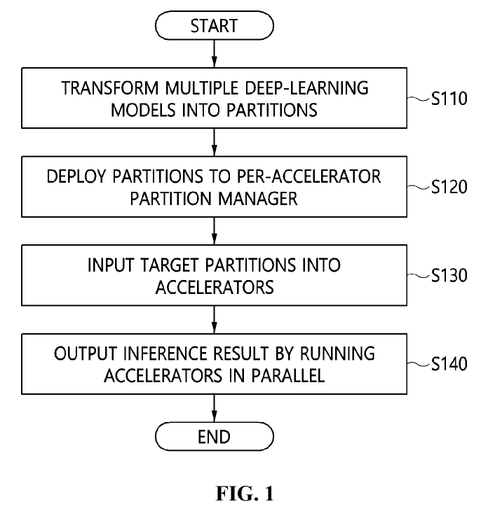

FIG. 1 is a flowchart illustrating a method for parallel inference for multiple deep-learning models according to an embodiment of the present disclosure.

Referring to FIG. 1, in the method for parallel inference for multiple deep-learning models according to an embodiment of the present disclosure, a parallel inference apparatus transforms each of multiple deep-learning models into partitions executable on accelerators by partitioning the deep-learning model at step S110.

Here, the partition includes a partition ID and partition code, and the partition code may be generated to correspond to code in a format executable on accelerators by optimizing the subgraphs to be executed on the accelerators.

Here, the operators of a graph acquired by performing hardware-independent graph optimization on the multiple deep-learning models may be matched with accelerators, and a single independent subgraph may be generated for consecutive operations executed on the same accelerator.

Here, matching the operators with the accelerators may be performed based on a partition performance model and the execution wait time of each accelerator such that the execution time of the entire subgraph is minimized.

Here, the partition performance model may include the partition execution time, which includes the time taken by an accelerator to execute the partition, the time required to transmit input data for executing the partition, and the time required to retrieve output data.

Here, the partition performance model may be generated by monitoring the performance of the accelerators over a preset period.

Here, the execution time of the entire subgraph may include the partition execution time, the time required to transmit/receive input/output data, and the execution wait time.

Also, in the method for parallel inference for multiple deep-learning models according to an embodiment of the present disclosure, the parallel inference apparatus deploys the partitions to per-accelerator partition managers based on the partition execution order determined in consideration of inter-partition dependencies at step S120.

Here, the partitions with a dependency relationship, in which the output of a preceding partition is used as the input of a subsequent partition, may be deployed to the partition managers of different accelerators, and information about matching between the partition and the partition manager and the order in which the partitions with a dependency relationship are executed may be managed by a multi-model execution manager.

Also, in the method for parallel inference for multiple deep-learning models according to an embodiment of the present disclosure, when input data for each target model is provided according to an inference execution request, the parallel inference apparatus extracts target partitions associated with the input data for the target model from the per-accelerator partition managers and inputs the target partitions into the accelerators matched therewith at step S130.

Also, in the method for parallel inference for multiple deep-learning models according to an embodiment of the present disclosure, the parallel inference apparatus runs the accelerators, into which the target partitions are input, in parallel and outputs the inference result for each target model at step S140.

Here, the accelerators into which the target partitions are input may be able to operate concurrently.

Here, the inference result may be generated upon completion of execution of the last target partition that constitutes the target model.

Through the above-described method for parallel inference for multiple deep-learning models, multiple models are executed in parallel by deploying the multiple models to various heterogeneous accelerators provided in a target device, whereby the overall execution time and response time of the multiple models may be minimized.

Also, a compiler capable of transforming a single deep-learning model into small units of code executable on accelerators is provided, whereby partitions may be effectively deployed and executed on accelerators on a target device.

Also, the development time of AI applications that require various deep learning models may be reduced, and execution performance may be improved.

Also, it is possible to concurrently operate multiple deep-learning models even in a device that is not equipped with high-performance GPUs and includes heterogeneous accelerators supporting only a specific operation.

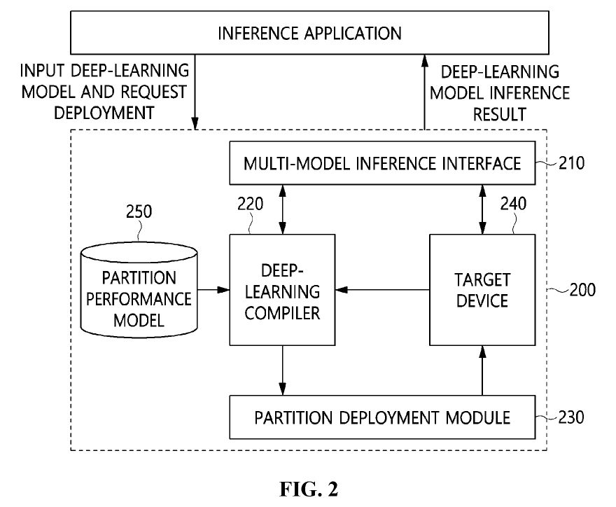

FIG. 2 is a view illustrating a system for parallel inference for multiple deep-learning models according to an embodiment of the present disclosure.

Referring to FIG. 2, the structure of a parallel inference apparatus and an example of a parallel inference process using the same according to an embodiment of the present disclosure are illustrated.

The parallel inference apparatus 200 according to an embodiment of the present disclosure is a system that operates by receiving input/output from an inference application.

The inference application provides a deep-learning model and input data (images, voice, etc.) for executing the model to the parallel inference apparatus 200 and receives an inference result output from the parallel inference apparatus 200.

The components of the parallel inference apparatus 200 and the roles of the components are as follows.

First, a multi-model inference interface 210 may receive a model to be deployed from the inference application and deliver the same to a deep-learning compiler 220. Also, the multi-model inference interface 210 receives input data required to execute the deployed model and delivers the same to the multi-model execution manager of a target device 240, which executes partitions, and may serve to receive the final inference result.

Here, each deep-learning model is identified using a model ID, and the deep-learning model described below may include both the model ID and data that constitutes the model. Also, a partition may include both a partition ID and partition code that constitutes the partition.

Also, the multi-model inference interface 210 may simultaneously receive the input of different deep-learning models from various applications. That is, before it receives output for a model, it may process input for another model.

Here, before completion of execution of all the partitions of a single model, the multi-model execution manager of the target device 240 may also send the partitions of another model to accelerator executors such that the partitions are concurrently executed. Here, a single accelerator executor is able to execute only one partition at a time, but N accelerator executors are able to concurrently operate, so up to N different partitions may be concurrently executed.

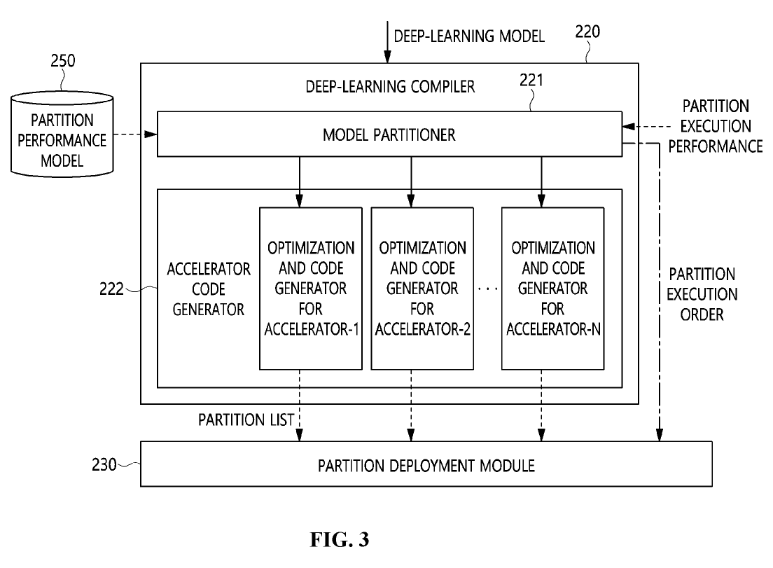

Hereinafter, the structure and operation process of the deep-learning compiler 220 will be described in detail with reference to FIG. 3.

First, a partition performance model 250 may correspond to a file or program that provides information about the time consumed for subgraphs, which are composed of individual operators and groups of consecutive operators that form a deep-learning model, to be compiled and executed on the target device 240.

Here, the partition execution time may include all of the time taken by an accelerator to execute a partition, the time required to transmit input data for executing the partition, and the time required to retrieve output data. Here, the number of operators included in a single partition may vary within a range from one to the total number of operators constituting the model.

A model partitioner 221 may perform hardware-independent graph optimization (operator fusion, constant folding, removal of inactive nodes, etc.) on the input deep-learning model and then match the operators of the graph with the accelerators on which the operators are to be executed.

Here, matching the operator with the accelerator may be performed using the partition wait time received from the partition performance model 250 and the runtime partition performance monitor of the target device 240 such that the execution time of the entire graph is minimized. The execution time of the entire graph may include the execution time of the partitions on the accelerators, the time required to transmit/receive input/output data, and the execution wait time.

Here, for an operation that cannot be processed by the accelerator, the execution time may be calculated as the maximum value that can be set.

Subsequently, based on the matching result, consecutive operations executed on the same accelerator are isolated into an independent subgraph, and information about the order of executing the subgraphs may be generated.

An optimization and code generator for each accelerator in an accelerator code generator 222 may receive the subgraph to be executed on each accelerator and perform accelerator hardware-dependent optimization (data layout optimization, quantization, pipelining, etc.). Through this process, code in a format executable on the accelerator may be generated for the subgraph and delivered to a partition deployment module 230.

The partition deployment module 230 may deliver the partitions generated by the deep-learning compiler to the partition managers assigned to respective accelerators.

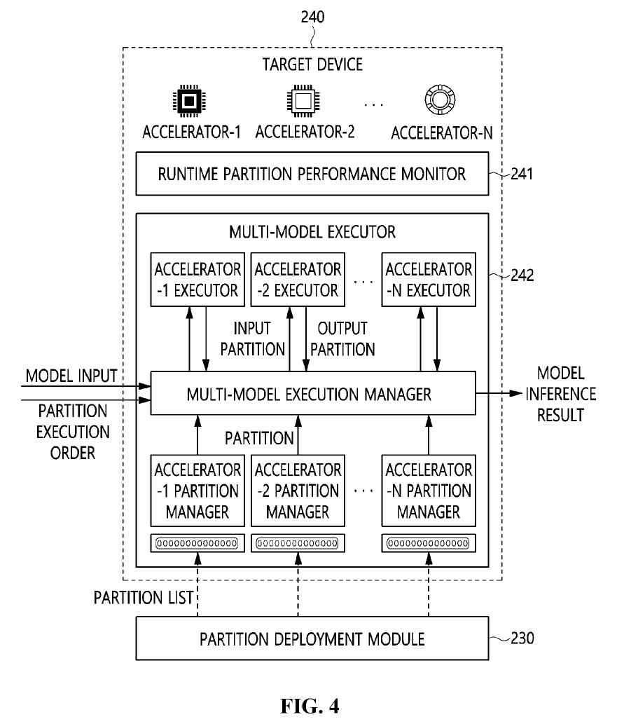

Hereinafter, the structure and operation process of the target device 240 including heterogeneous accelerators will be described in detail with reference to FIG. 4.

The runtime partition performance monitor 241 may serve to deliver the partition execution wait time measured during a specific period specified by a user to the model partitioner 221 of the deep-learning compiler 220.

A per-accelerator partition manager may store partitions to be executed on the accelerator in a buffer. For example, when a multi-model execution manager requests a partition of a specific model, the per-accelerator partition manager may search for the requested partition in the buffer and provide the same.

Upon receiving a model removal request from an inference application, the multi-model execution manager may remove the partitions of the corresponding model from the per-accelerator partition manager.

Also, upon receiving model input, the multi-model execution manager may retrieve target partitions associated with the target model to process the input from the per-accelerator partition manager and execute the target partitions on a per-accelerator executor.

Here, when there is a dependency relationship between the partitions (the output of a preceding partition is used as the input of a subsequent partition), the multi-model execution manager sequentially retrieves the partitions from the per-accelerator partition manager(s) and executes the partitions in order. However, when there is no dependency relationship between the partitions and when the partitions are allocated to different accelerators, the multi-model execution manager executes the partitions in parallel using different accelerator executors. For example, partitions belonging to different models may be processed in parallel using different accelerators because there is no dependency relationship therebetween.

Here, upon completion of execution of the last partition that constitutes the target model, an inference result value (or the memory address where the output result value is stored) may be delivered to the multi-model inference interface 210.

After receiving partition input data and partition code from the multi-model execution manager, the accelerator executor may deliver the partition input data and partition code to the accelerator and execute the same. Also, it may deliver the final execution result obtained through execution to the multi-model execution manager.

Using the above-described parallel inference apparatus 200, multiple deep-learning inference models may be concurrently executed by maximally utilizing the heterogeneous accelerator resources included in the target device 240.

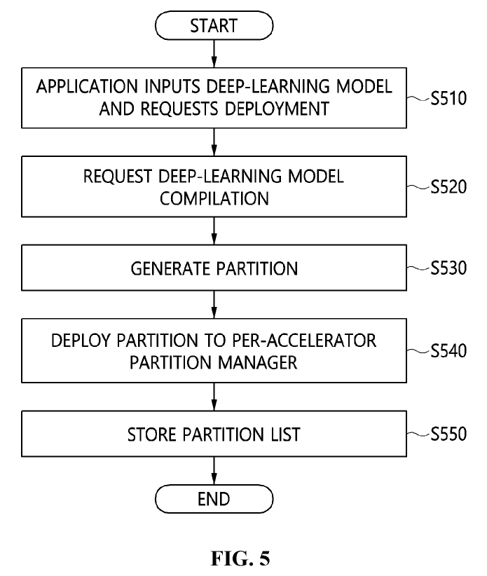

FIG. 5 is a flowchart illustrating in detail a model deployment procedure in a parallel inference method according to an embodiment of the present disclosure.

Referring to FIG. 5, in the model deployment procedure in the parallel inference method according to an embodiment of the present disclosure, first, an application may deliver a request to deploy a deep-learning model when it delivers the deep-learning model to the multi-model inference interface at step S510.

Subsequently, the multi-model inference interface may request the deep-learning compiler to compile the deep-learning model at step S520.

Subsequently, the deep-learning compiler may partition the deep-learning model based on information about the execution wait time of each accelerator, which is received from the partition performance model and the runtime partition performance monitor, thereby generating partitions corresponding to code for accelerators at step S530.

Here, each accelerator may be assigned multiple partitions to be executed, and execution information for the partitions executed on each accelerator may be generated by the model partitioner.

Subsequently, the partition deployment module may receive the generated partition list and a partition execution order from the deep-learning compiler and deploy the partitions to the per-accelerator partition managers and the multi-model execution manager at step S540.

Subsequently, the per-accelerator partition manager may receive the partition list from the partition deployment module and store the same in memory at step S550.

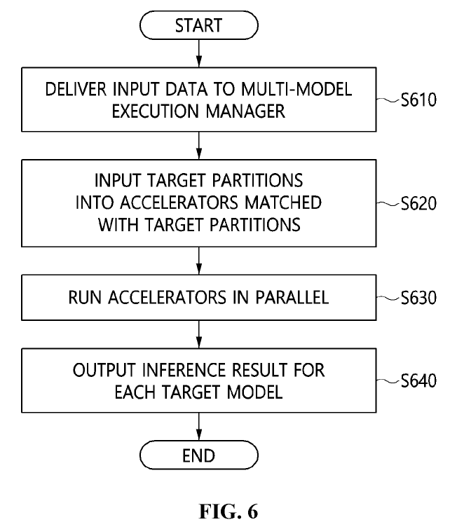

FIG. 6 is a flowchart illustrating in detail a model execution procedure in a parallel inference method according to an embodiment of the present disclosure.

Referring to FIG. 6, in the model execution procedure in the parallel inference method according to an embodiment of the present disclosure, first, when it receives input data for model execution from an application, the multi-model inference interface may deliver the input data to the multi-model execution manager running on the target device at step S610.

Subsequently, based on the partition execution information obtained by compiling the target model associated with the input data, the multi-model execution manager may retrieve the target partitions to be executed from a per-accelerator partition manager and input the target partitions into the accelerator executors matched with the target partitions at step S620.

Subsequently, the accelerator executors into which the target partitions are input are run in parallel at step S630, and the inference result for each target model may be output based on the output value of the accelerator executor at step S640.

Here, running the per-accelerator executors in parallel may be performed in such a way that the output value of the previously executed partition is delivered as the input value to the partition to be subsequently executed. Accordingly, the output value of the last partition in the partition execution order may be delivered to the multi-model inference interface as the execution result of the model constituted by the partitions.

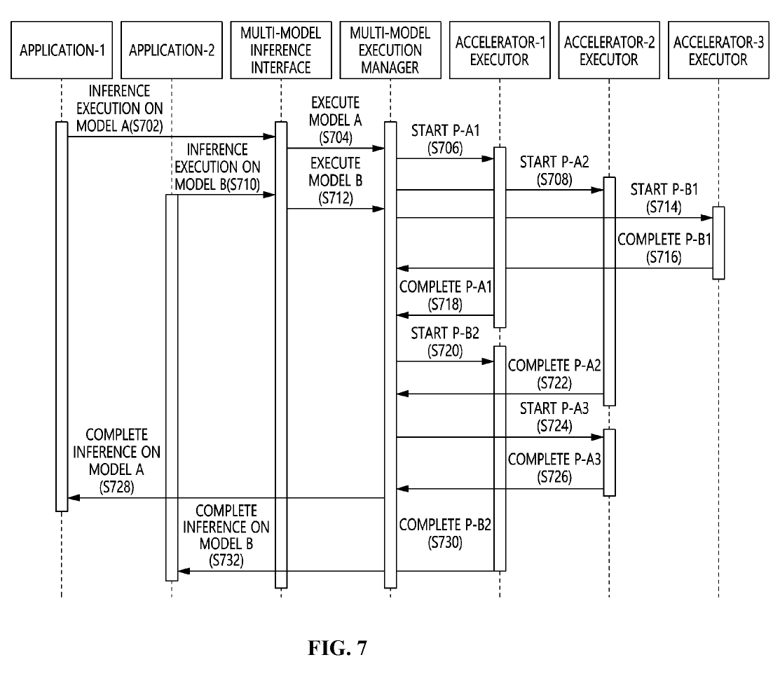

FIG. 7 is a view illustrating an example of the process of executing two deep-learning models in parallel across three accelerators according to the present disclosure.

Referring to FIG. 7, the procedure of concurrently executing two deep-learning models in a parallel inference apparatus according to the present disclosure is illustrated.

Here, model A may be transformed into three partitions corresponding to P-A1, P-A2, and P-A3 and the partition execution order corresponding to P-A1 -> P-A2 -> P-A3 through a deep-learning compiler. Subsequently, the partitions of model A may have been delivered to per-accelerator partition managers and a multi-model execution manager through a partition deployment module.

Also, model B may be transformed into two partitions corresponding to P-B1 and P-B2 and the partition execution order corresponding to P-B1 -> P-B2 through the deep-learning compiler. Subsequently, the partitions of model B may also have been delivered to the per-accelerator partition managers and the multi-model execution manager through the partition deployment module.

Subsequently, according to the process illustrated in FIG. 7, application 1 may request inference execution on model A at step S702.

Here, when inference execution is requested, input data for model execution may be provided together.

Subsequently, upon receiving the request for inference execution, a multi-model inference interface may deliver a request to execute model A to the multi-model execution manager at step S704.

Subsequently, the multi-model execution manager sequentially receives the partitions acquired by compiling model A from accelerator managers and delivers the partitions to accelerator executors matched with the partitions, thereby executing the partitions at steps S706, S708, and S724.

Here, before execution of the three partitions corresponding to model A is completed, application 2 may request inference execution on model B at step S710.

Subsequently, upon receiving the request for inference execution, the multi-model inference interface may deliver a request to execute model B to the multi-model execution manager at step S712.

Subsequently, the multi-model execution manager sequentially receives the partitions acquired by compiling model B from the accelerator managers and delivers the partitions to the accelerator executors matched with the partitions, thereby executing the partitions at steps S714 and S720.

That is, the multi-model execution manager delivers requests to start execution of the partitions to the accelerator executors until there are no more partitions to execute for each of model A and model B, and upon completion of execution of the respective partitions at steps S716, S718, S722, S726, and S730, the multi-model execution manager may deliver execution completion responses along with partition output data to the respective applications at step S728 and S732.

Here, when execution of the last partitions of the respective models is completed, the partition output data and the execution completion responses may be delivered.

For example, in the case of model A, when execution of P-A3 is completed at step S726, partition output data of P-A3 and the execution completion response may be delivered to application 1 at step S728.

In another example, in the case of model B, when execution of P-B2 is completed at step S730, partition output data of P-B2 and the execution completion response may be delivered to application 2.

According to the present disclosure, the overall model processing time may be reduced by partitioning multiple deep-learning models into partitions corresponding to constituent units and allocating the respective partitions to appropriate heterogeneous accelerators based on a performance model.

In addition, matching operators with accelerators is optimized through a runtime performance model configured by measuring performance of each accelerator in advance. Accordingly, automatic parallelization based on static compilation may be realized, which may significantly reduce model deployment and tuning costs when AI applications are developed.

Also, the present disclosure provides a compiler structure capable of transforming a single deep-learning model into small units of code executable on accelerators, thereby effectively deploying and executing partitions on accelerators on a target device.

Also, the present disclosure may reduce the development time of AI applications requiring various deep-learning models and improve the execution performance.

Also, the present disclosure may enable multiple deep-learning models to operate concurrently even on a device that includes heterogeneous accelerators supporting only a specific operation, without high-performance GPUs.

As described above, the method for parallel inference for multiple deep-learning models and the apparatus for the same according to the present disclosure are not limitedly applied to the configurations and operations of the above-described embodiments, but all or some of the embodiments may be selectively combined and configured, so the embodiments may be modified in various ways.

What is claimed is:

1. A method for parallel inference, performed by a parallel inference apparatus, comprising:
transforming each of multiple deep-learning models into partitions executable on accelerators by partitioning the deep-learning model;
deploying the partitions to per-accelerator partition managers based on a partition execution order determined in consideration of inter-partition dependencies;
extracting target partitions associated with input data for each target model from the per-accelerator partition managers and inputting the extracted target partitions into accelerators matched with the target partitions when the input data for each target model is provided according to an inference execution request; and
outputting an inference result for each target model by running the accelerators, into which the target partitions are input, in parallel.

2. The method of claim 1, wherein
the partition includes partition code and a partition ID, and
the partition code is generated to correspond to code in a format executable on accelerators by optimizing subgraphs to be executed on the accelerators.

3. The method of claim 2, wherein transforming each of the multiple deep-learning models comprises matching operators of a graph, acquired by performing hardware-independent graph optimization on the multiple deep-learning models, with accelerators and generating a single independent subgraph for consecutive operations executed on an identical accelerator.

4. The method of claim 3, wherein matching the operators with the accelerators is performed based on a partition performance model and an execution wait time of each accelerator such that an execution time of the entire subgraph is minimized.

5. The method of claim 4, wherein the partition performance model includes a partition execution time, including a time taken by an accelerator to execute a partition, a time required to transmit input data for executing the partition, and a time required to retrieve output data.

6. The method of claim 4, wherein the partition performance model is generated by monitoring performance of the accelerators over a preset period.

7. The method of claim 4, wherein the execution time of the entire subgraph includes a partition execution time, a time required to transmit/receive input/output data, and an execution wait time.

8. The method of claim 1, wherein the accelerators into which the target partitions are input are capable of concurrently operating.

9. The method of claim 1, wherein the inference result is generated upon completion of execution of a last target partition that constitutes the target model.

10. An apparatus for parallel inference, comprising:
a deep-learning compiler for transforming each of multiple deep-learning models into partitions executable on accelerators by partitioning the deep-learning model;
a partition deployment module for deploying the partitions to per-accelerator partition managers based on a partition execution order determined in consideration of inter-partition dependencies; and
a multi-model execution module for extracting target partitions associated with input data for each target model from the per-accelerator partition managers and inputting the extracted target partitions into accelerators matched with the target partitions when the input data for each target model is provided according to an inference execution request, and for outputting an inference result for each target model by running the accelerators, into which the target partitions are input, in parallel.

11. The apparatus of claim 10, wherein
the partition includes partition code and a partition ID, and
the partition code is generated to correspond to code in a format executable on accelerators by optimizing subgraphs to be executed on the accelerators.

12. The apparatus of claim 11, wherein the deep-learning compiler matches operators of a graph, acquired by performing hardware-independent graph optimization on the multiple deep-learning models, with accelerators and generates a single independent subgraph for consecutive operations executed on an identical accelerator.

13. The apparatus of claim 12, wherein matching the operators with the accelerators is performed based on a partition performance model and an execution wait time of each accelerator such that an execution time of the entire subgraph is minimized.

14. The apparatus of claim 13, wherein the partition performance model includes a partition execution time, including a time taken by an accelerator to execute a partition, a time required to transmit input data for executing the partition, and a time required to retrieve output data.

15. The apparatus of claim 13, further comprising:
a runtime partition performance monitor for generating the partition performance model by monitoring performance of the accelerators over a preset period.

16. The apparatus of claim 13, wherein the execution time of the entire subgraph includes a partition execution time, a time required to transmit/receive input/output data, and an execution wait time.

17. The apparatus of claim 10, wherein the accelerators into which the target partitions are input are capable of concurrently operating.

18. The apparatus of claim 10, wherein the inference result is generated upon completion of execution of a last target partition that constitutes the target model.
